(19) United States
(12) Patent Application Publication
(10) Pub. No.: US 2026/0274647 A1
(43) Pub. Date: Sep. 17, 2026

(54) PROTECTION FOR HORSE GUMS

(71) Applicant: STHOD'S, Frameries (BE)

(72) Inventor: Sébastien Tirtey, Donceel (BE)

(73) Assignee: STHOD'S, Frameries (BE)

(21) Appl. No.: 19/167,478

(22) PCT Filed: Mar. 21, 2024
(86) PCT No.: PCT/EP2024/057680

§ 371 Date: Sep. 22, 2025

(30) Foreign Application Priority Data
Mar. 24, 2023 (BE) BE2023/5231

(51) Int. Cl. B68B 7/00; A01K 13/00

(52) U.S. Cl. CPC B68B 7/00; A01K 13/006

(57) ABSTRACT

A protection device for horse gums is disclosed. The protection device includes an inner holding portion for positioning in a mouth of the horse and incorporating a protective element an outer holding portion positioned outside the mouth of the horse in contact with a posterior part of a head of the horse; the protection device being configured to attach to a mandible of the horse when the inner holding portion is positioned in the mouth of the horse so that the protective element prevents a direct contact between the mandibular bar and a bit installed in the mouth of the horse, and the outer holding portion is positioned outside the mouth of the horse and in contact with the posterior part of the head of the horse.

### TECHNICAL FIELD

According to a first aspect, the invention relates to a protection to prevent a direct contact between a mandibular bar of a horse and a bit installed in a mouth of the horse. The invention also proposes a method for attaching such a protection to the lower jaw of a horse. The invention also proposes a method and a protective element for protecting a horse's mandibular bar.

### BACKGROUND

A horse bit allows a rider to act on the mouth of the horse by means of the reins. In particular, this allows the rider to indicate a direction for the horse to follow. A bit is typically placed across the mouth of the horse and at the level of the corners of the lips. Generally speaking, the bit inserted into the mouth of the horse rests on parts of the gums of the horse covering each of its two mandibular bars. The mandibular bars of the horse are toothless spaces in the lower jaw located between the premolars and the incisors, or between the premolars and the canines if the horse has canines. The bit installed in the mouth of the horse is therefore in direct contact with the gums of the mandibular bars.

The bit installed in the mouth of the horse moves in relation to the jaws, particularly when the rider biases the bit by pulling on the reins connected to it. The bit then rubs against the gums of the mandibular bars, injuring said gums. Such injuries make it more painful for the bit to rub against the gums and cause hypersensitivity. This has a negative impact on the well-being of the horse.

Moreover, the pain caused by the bit rubbing against the gums of the horse results in a loss of communication between the horse and his rider. This has a negative impact on the horse's responsiveness to its rider's instructions, and therefore on the sporting performance of both the horse and the rider in competition.

The document WO201039025A1 describes a device configured to be placed in the horse's mouth and comprising protective parts to cover the bars. When the device is placed in a horse's mouth, it is attached both around the teeth and between the front teeth and molars of the horse. Holding such a device in a horse's mouth therefore requires a design adapted to the shape of the jaw and teeth of each particular horse, so as to fit it snugly.

There is therefore a need for a protection that allows to prevent a direct contact between a bit inserted into a horse's mouth and the horse's mandibular bars, and that has reduced adaptations required to be held in position in a particular horse's mouth.

### SUMMARY OF THE INVENTION

One object of the present invention is to provide a protection for horse gums which minimizes the adaptations required to be held in position in the mouth of a particular horse.

According to a first aspect, the invention relates to a protection for horse gums comprising:
an inner holding portion comprising a protective element and configured to be positioned in a mouth of a horse such that the protective element prevents a direct contact between a mandibular bar of the horse and a bit inserted into the horse's mouth,
an outer holding portion to be positioned outside the mouth of the horse against a posterior part of the horse's head.

Compared to the prior art, the protection according to the invention does not require bespoke manufacture to ensure that it is held in the mouth of a particular horse. Thanks to the inner and outer holding portions, it is not necessary to conform to the shape of the horse's jaw and teeth with the protection in order to hold it in the horse's mouth.

The protection according to the invention is configured to protect at least one portion of horse's gum covering a mandibular bar from rubbing generated by a movement of the bit in the horse's mouth.

The protection according to the invention is preferably configured to be coupled to a lower jaw of the horse when:
the inner holding portion is positioned in the horse's mouth so that the protective element prevents the direct contact between the horse's mandibular bar and the bit in the horse's mouth, and
the outer holding portion is positioned outside the horse's mouth and against the posterior part of the horse's head.

Preferably, the protection is configured to be coupled only to the lower jaw of the horse. This type of protection allows to avoid unnecessarily constraining movements between the jaws of the horse.

Preferably, the outer holding portion is configured to be positioned against the chin and/or the intermandibular region of the horse's head. In this way, the protection may be achieved with a reduced overall dimension.

The posterior part of the horse's head comprises the chin and the intermandibular region of the horse's head.

When the protection is coupled to the horse's lower jaw, the outer holding portion is preferably configured to be in contact with the posterior part of the horse's head. The contact between the outer holding portion and the posterior part of the horse's head may be direct or indirect. In the context of this application, such an outer holding portion may also be referred to as a ‘head posterior part contact portion’, or an ‘outer portion of contact of head posterior part’. In the context of the present application, the outer holding portion may also be referred to as the ‘intermandibular region contact portion’, or the ‘outer intermandibular region contact portion’ when the outer holding portion is configured to be positioned against the intermandibular region of the horse's head. In the context of this application, the outer holding portion may also be referred to as the ‘chin contact portion’, or ‘outer chin contact portion’ when the outer holding portion is configured to be positioned against the chin of the horse's head.

The outer holding portion may comprise a head posterior part contact surface. The head posterior part contact surface is in contact with the posterior part of the horse's head when the protection is coupled to the horse's lower jaw. In other words, the outer holding portion is in contact with the posterior part of the horse's head through the head posterior part contact surface when the protection is coupled to the horse's lower jaw. The contact between the head posterior part contact surface and the posterior part of the horse's head may be direct or indirect.

Alternatively, the head posterior part contact surface may be referred to as a ‘intermandibular region contact surface’ or a ‘chin contact surface’ when the outer holding portion is configured to be positioned against the intermandibular region and/or the chin of the horse's head, respectively.

Preferably, the protection is configured so that the outer holding portion is held against the posterior part of the horse's head by a bridle attached to the horse's head when the protection is coupled to the horse's jaw. This allows to ensure that the coupling between the protection and the horse's head remains reliable, even in the event of sudden movement of the horse's head.

Preferably, the outer holding portion is configured to be held against the posterior part of the horse's head by a bridle attached to the horse's head, preferably by a strap of the bridle attached to the horse's head. Preferably, the bridle prevents the outer holding portion from moving away from the posterior part of the horse's head. Preferably, the outer holding portion is configured to be positioned between the posterior part of the horse's head and a part of the bridle surrounding the horse's head. Preferably, the outer holding portion is configured to be positioned between the posterior part of the horse's head and a part of the bridle surrounding the horse's head such that the bridle prevents movement of the outer holding portion in a direction normal to a portion of an outer surface of the posterior part of the horse's head in contact with the outer holding portion.

Preferably, the outer holding portion has a shape configured to limit lateral displacements of the outer holding portion relative to the horse's lower jaw when the protection is coupled thereto. Preferably, such an outer holding portion partially conforms to the shape of the posterior part of the horse's head. Preferably, such an outer holding portion partially surrounds the posterior part of the horse's head.

In a preferred embodiment of the invention, the outer holding portion comprises a bridle contact surface opposite the head posterior part contact surface. The protection is configured so that the bridle, preferably the strap of the bridle, is in contact with the bridle contact surface when the outer holding portion is held against the posterior part of the horse's head by the bridle attached to the horse's head.

Preferably, the bridle contact surface comprises one or more protuberances. Each protuberance projects from the bridle contact surface. Each protuberance extends from the bridle contact surface. Each protuberance preferably extends at least in a direction normal to the bridle contact surface. The protuberances are spaced apart to allow the strap of the bridle to be positioned between the protuberances when the outer holding portion is held against the posterior part of the horse's head by the bridle attached to the horse's head. The protuberances are configured to prevent a movement of the strap along the bridle contact surface. Such protuberances therefore allow the protection to be held in place better by the bridle, preventing the strap from slipping next to the bridle contact surface of the outer holding portion.

In a preferred embodiment, the inner holding portion is coupled to the outer holding portion via a junction portion. The junction portion connects the inner and outer holding portions. Preferably, the junction portion is configured to surround the horse's lower jaw when the protection is coupled to said lower jaw. The junction portion preferably has an arcuate portion.

In a preferred embodiment, the protection according to the invention comprises two lateral parts each comprising an inner holding portion, the protection being configured so that the protective element of each lateral part prevents the direct contact between a respective mandibular bar and the bit. In this way, the protection allows to protect the two mandibular bars of a horse from the rubbing of a bit.

The protection according to the invention therefore preferably comprises two lateral parts. Each lateral part comprises an inner holding portion comprising a respective protective element. The inner holding portions are configured to both be positioned in a horse's mouth so that each protective element prevents a direct contact between a respective mandibular bar and the bit inserted into the horse's mouth.

Such a protection comprising the two lateral parts is preferably configured to be coupled to the horse's lower jaw when:
the inner holding portions are positioned in the horse's mouth so that their respective protective elements each prevent the direct contact between one of the horse's mandibular bars and the bit inserted in the horse's mouth, and
the outer holding portion is positioned outside the horse's mouth and held against the posterior part of the horse's head, preferably by a strap of a bridle attached to the horse's head.

In the context of this application, coupling the protection to the horse's lower jaw means that the protection is attached to the horse's lower jaw.

In a preferred embodiment, the protection comprises two junction portions, and each lateral part is mechanically coupled to the outer holding portion through one of the respective junction portions, the two lateral parts preferably being symmetrical with respect to a plane of symmetry of the protection. Preferably, the junction portions are configured to laterally surround the horse's lower jaw on either side of the horse's lower jaw. In this way, the junction portions allow to limit the movements of the protection in the lateral direction of the horse's lower jaw when the protection is coupled to the horse's lower jaw. This helps to ensure that the protection is correctly positioned in relation to the horse's lower jaw.

Preferably, the protective element is removably attached to a mechanical coupling portion of the inner holding portion. In this way, it is possible to replace the protective element or elements of the protection without replacing the entire protection. This type of protection also allows to attach protective elements made from materials of different hardness. For example, a protective element more or less flexible may be chosen according to the horse's sensitivity.

Preferably, the protective element is attachable to a coupling portion of the inner holding portion by threading. For example, the coupling portion of the inner holding portion comprises a rod for threading into a housing in the protective element. Such a protective element may be according to the fourth aspect of the invention described below. Alternatively or concomitantly, the protective element may be attached to the coupling portion of the inner holding portion by adhesive bonding.

Alternatively, the inner holding portion comprising the protective element may be one-part. In the case where the inner holding portion comprising the protective element is one-part, this means that the protective element may not be decoupled from the inner holding portion and that the inner holding portion comprising the protective element is made in one piece.

In such a configuration where the inner holding portion comprising the protective element is one-part, the protective element may be according to the fourth aspect of the invention, but without the housing for receiving a rod.

Preferably, the protective element comprises a main tongue for at least partially covering the mandibular bar. This simplifies the design of the protective element to avoid the direct contact between the bit and the horse's gum.

The protective element is preferably configured to extend into a space between the incisors (or the canines if the horse has them) and the premolars of a horse when the protection is coupled to the lower jaw of a horse. Typically, the distance between a horse's incisors and premolars is 7 cm. A typical length of the main tongue measured along an axis X is therefore 7 cm.

In one embodiment, a length of the main tongue of the protective element measured along the axis X of the protective element is between 3 and 10 cm, preferably between 5 and 8 cm. In one embodiment, a width of the main tongue of the protective element measured along an axis Y of the protective element orthogonal to the axis X is between 2 and 5 cm, preferably between 3 and 4 cm. The protection is preferably configured so that the longitudinal direction of the main tongue is aligned with a length direction of the mandibular bar protected by the main tongue when the protection is coupled to the lower jaw of a horse. The length direction of the mandibular bar corresponds to an axis passing through an incisor and a premolar adjacent to said mandibular bar.

The protection according to the invention is preferably configured so that the protective element prevents the direct contact between the horse's mandibular bar and the bit inserted into the horse's mouth when the inner holding portion is positioned in the horse's mouth relative to the mandibular bar and the outer holding portion is positioned outside the horse's mouth against the posterior part of the horse's head.

Preferably, the inner holding portion is configured to allow the protection to be positioned relative to a horse's lower jaw. The inner holding portion is preferably configured to allow positioning of the protection relative to a tooth, preferably a premolar adjacent to the mandibular bar, of a lower jaw of the horse. The inner holding portion may be configured to allow the protection to be positioned relative to a mandibular bar.

In the present application, it will be clear to the person skilled in the art that the term mandibular bar refers to a part of the horse's lower jaw which has no teeth and separates a premolar and an incisor (or possibly a canine if the horse has one), the mandibular bar comprising a gum which covers it.

The inner holding portion comprises a protective element to protect the horse's gums. The inner holding portion is configured to be positioned in the horse's mouth so that the protective element prevents a direct contact between a mandibular bar of the horse and a bit inserted into the horse's mouth, i.e. between the gum of the mandibular bar and the bit.

The protective element of the inner holding portion is preferably configured to be in contact with the mandibular bar of the horse when the protection is coupled to the lower jaw of the horse. The contact between the protective element and the mandibular bar may be direct or indirect. In the context of this application, such a protective element may also be referred to as a ‘gum contact element’, or ‘gingival contact element’, or ‘mandibular bar contact element’.

The protective element may comprise a gingival contact face. The gingival contact face is in contact with the horse's mandibular bar when the protection is coupled to the horse's lower jaw. In other words, the protective element of the inner holding portion is in contact with the mandibular bar of the horse through the gingival contact face when the protection is coupled to the lower jaw of the horse. The contact between the gingival contact face and the mandibular bar may be direct or indirect. More specifically, the contact occurs between the gingival contact face and the gum of the mandibular bar.

Preferably, the gingival contact face comprises a curved, concave part to receive the mandibular bar. This allows to cover and at least partially surround a horse's mandibular bar when the protection is coupled to the horse's mandible. This ensures that the protection stays in place better in the horse's mouth.

Preferably, the protective element comprises a protrusion, also referred to as a rim in this application, for positioning between the tongue and the mandibular bar of the horse when the protection is coupled to the lower jaw of the horse.

In the context of this application, the gingival contact face of the protective element may also be referred to as the ‘gum contact surface’ or ‘mandibular bar contact face’.

Each protective element may comprise a mandibular bar contact surface for contacting a respective mandibular bar.

Similarly, where the protection comprises a plurality (typically 2) of outer holding portions, each outer holding portion may comprise a head posterior part contact surface for contacting a respective part of the posterior part of the horse's head, for example the chin or the intermandibular region.

In one embodiment of the invention, the protection comprises a transverse plane. The transverse plane separates the gingival contact face or surfaces from the contact surface or surfaces on the posterior part of the head of the protection. In other words, the gingival contact faces and the posterior head part contact surfaces are located on either side of the transverse plane. The gingival contact face or faces are oriented towards a first face of the transverse plane. The head posterior part contact surface or surfaces are oriented towards a second face of the transverse plane opposite the first face of the transverse plane. This configuration ensures the holding of the protection on the horse's head because, when the protection is coupled to the horse's head:
the gingival contact faces prevent the protection from moving downwards, i.e. towards the posterior part of the horse's head,
the contact surfaces on the posterior part of the head prevent the protection from moving upwards.

Preferably, the transverse plane is orthogonal to the plane of symmetry of the protection. Preferably, the protection is configured so that the transverse plane is substantially parallel to the length direction of each of the mandibular bars when the protection is coupled to the horse's head.

Preferably, the protection is configured to be coupled to a lower jaw of the horse such that:
the protective element at least partially covers the mandibular bar, or each of the protective elements at least partially covers a respective mandibular bar, and
the outer holding portion is positioned against the posterior part of the horse's head and preferably held against the posterior part by the bridle attached to the horse's head,
preferably, the junction portions surround laterally the horse's lower jaw on either side of the horse's lower jaw.

Such a protection comprising junction portions configured to laterally surround the horse's lower jaw on either side thereof allows the bit to keep freedom of action when the protection is coupled to the lower jaw.

The horse's lower jaw is also generally referred to as the ‘mandible’.

In a preferred embodiment of the protection according to the invention, the inner holding portion or portions are configured to allow a positioning of the protection relative to a mandibular bar of the horse, preferably relative to teeth (e.g. premolars and/or incisors) and to a gum of the lower jaw of the horse. Each inner holding portion is preferably configured to allow the protection to be positioned relative to the horse's jaw, preferably relative to a mandibular bar of the horse. Preferably, each inner holding portion is configured to allow the protection to be positioned relative to teeth (e.g. premolars and/or incisors of the lower jaw) and/or to a gum covering the mandibular bar.

Preferably, each inner holding portion is configured to extend along a respective mandibular bar between the incisor (or canine if the horse has one) and the premolar adjacent to said mandibular bar. In this way, the incisor (or the canine if the horse has one) helps to limit forward displacement of the inner holding portion in the horse's mouth when the protection is coupled to the horse's mouth. In other words, the incisor (or the canine if the horse has one) acts as a stop limiting the movement of the inner holding portion towards the front of the horse's mouth. Alternatively or concomitantly, the premolar helps to limit a rearward displacement of the inner holding portion in the horse's mouth when the protection is coupled to the horse's mouth. In other words, the premolar acts as a stop limiting the movement of the inner holding portion towards the back of the horse's mouth.

Each inner holding portion is preferably configured to be positioned on a respective mandibular bar. This allows to limit any downward movement of the protection in the horse's mouth when the protection is coupled to the horse's mouth.

Preferably, the inner holding portions are shaped to limit a lateral movement of the protection in the horse's mouth when the protection is coupled to the horse's mouth. For example, such inner holding portions are configured to conform to a surface of the part of the gum overlying the mandibular bars and/or partially surround the mandibular bars.

In one example of embodiment of the protection used according to the invention, the coupling portion or portions of the inner holding portions, the outer holding portion and the junction portions are in a single piece, i.e. in one-part. Preferably, the coupling portion or portions of the inner holding portions, the outer holding portion and the junction portions are made of thermoplastic, for example polypropylene, polyamide, elastomeric thermoplastic or polyurethane thermoplastic. This makes it easier to manufacture the protection.

Preferably, the protective element or elements are made of a thermoplastic such as an elastomeric thermoplastic or a polyurethane thermoplastic. Thanks to these materials, the protective elements in contact with the gums are softer and/or smoother, which improves the horse's comfort.

Preferably, the outer holding portion has a head posterior part contact surface configured to be brought into contact with the posterior part of the horse's head and at least partially covered by a layer of soft and/or flexible material such as foam, latex or a material from the thermoplastic family. Preferably, the posterior part contact surface comprises a thermoplastic. In this way, the outer holding portion is at least partially covered with a layer of soft and/or flexible material such as thermoplastic, foam or latex. Preferably, the protection is configured such that said head posterior part contact surface comprising the layer of soft and/or flexible material is in contact with the posterior part of the head when the protection is coupled to the lower jaw of the horse. This improves the horse's comfort and reduces the risk of injury caused by movements of the outer holding portion in contact with the horse's skin and/or coat.

In one embodiment, the outer holding portion extends in a first direction over a distance of between 3 and 10 cm, preferably between 5 and 8 cm. In one embodiment, the outer holding portion extends in a second direction orthogonal to the first direction over a distance of between 8 and 15 cm, preferably between 10 and 14 cm. Preferably, the outer holding portion is configured to extend on either side of the horse's intermandibular region in the lateral direction of the horse's head when the protection is coupled to the horse's lower jaw, preferably so as to surround the horse's intermandibular region.

Thanks to the presence of the inner and outer holding portions, the protection according to the invention minimizes the adaptations required to couple the protection to the lower jaw of a particular horse. The protection according to the invention also offers the following advantages. It makes it easier and safer to fit the protection to a horse. In fact, the outer holding portion of the protection may constitute a gripping element allowing a person to install the protection in the horse's mouth without inserting his hands inside the horse's mouth, and in particular without passing his hands between the horse's jaws. This makes it easier and safer to fit the protection to a horse. The invention also eliminates the need to bond the protection in the horse's mouth in order to couple it to the horse's jaw. Finally, the outer holding portion is located outside the horse's mouth when the protection is coupled to the horse's lower jaw. The outer holding portion is therefore easily visible from outside the horse's mouth. This makes it easier to detect any incorrect positioning of the gum protection in relation to the horse's mouth. The protection provided by the invention therefore allows to protect the horse's gums more reliably.

According to a second aspect, the invention relates to a method for attaching, i.e. coupling, a horse gum protection to a mandible of a horse. The horse gum protection may be according to the first aspect of the invention, but not necessarily. The method comprises the following steps:
positioning an inner holding portion in a mouth of the horse so that a protective element of the inner holding portion prevents a direct contact between a mandibular bar of the horse and a bit inserted into the mouth of the horse;
positioning an outer holding portion of the protection outside the horse's mouth and against a posterior part of the horse's head.

The horse gum protection may comprise two inner holding portions. In this case, the method may comprise, for each of the two inner holding portions, a respective step of:
positioning an inner holding portion in a horse's mouth so that the protective element of the inner holding portion prevents a direct contact between a mandibular bar of the horse and the bit inserted in the horse's mouth.

Preferably, the method according to the invention comprises a step of:
holding the outer holding portion in contact with the posterior part of the horse's head by means of a bridle attached to the horse's head.

Preferably, the method according to the invention comprises:
positioning the outer holding portion of the protection between the posterior part of the horse's head and a strap of a bridle attached to the horse's head so as to hold the outer holding portion in contact with the posterior part of the horse's head.

In the method according to the invention, the inner holding portion is preferably positioned in the horse's mouth so that the protective element at least partially covers the mandibular bar. This allows to prevent a direct contact between the bit positioned in the horse's mouth and the bit inserted in the horse's mouth and in contact with the horse's corners, so that the bit is supported indirectly by the mandibular bar through the protective element.

This method allows the protection to remain attached to the horse's mandible even in the event of a sudden movement of the horse's head.

According to a third aspect, the invention concerns a method for protecting a horse's gum. The method comprises the following steps:
at least partially covering a mandibular bar in the horse's mouth with a protective element,
positioning the outer holding portion outside the horse's mouth against the posterior part of the horse's head,
positioning a junction portion mechanically coupling the protective element to the outer holding portion so that, when the protective element at least partially covers the mandibular bar and the outer holding portion is positioned outside the horse's mouth against the posterior part of the horse's head, the junction portion surrounds the horse's lower jaw.

In the method, the junction portion is preferably positioned to at least partially, but not entirely, surround the horse's lower jaw.

Preferably, the junction portion is positioned to surround laterally the horse's jaw, i.e. passing through one side of the horse's jaw.

It is possible to protect the two mandibular bars of a horse with two respective protective elements. In this case, the method may comprise, for each protective element and its respective mandibular bar, the step of:
at least partially cover the mandibular bar with the protective element.

In such an embodiment of the method, each protective element is preferably mechanically coupled to the outer holding portion by a respective junction portion. In this case, the method may comprise the following step twice, for each of the junction portions and its respective protective element:
positioning the junction portion mechanically coupling the protective element to the outer holding portion so that, when the protective element at least partially covers the mandibular bar and the outer holding portion is positioned outside the horse's mouth against the posterior part of the horse's head, the junction portion surrounds the horse's lower jaw.

In such an embodiment, the junction portions preferably surround laterally the horse's lower jaw and on opposite sides of the horse's head.

In the present application, the term lateral to characterize positioning in relation to the horse's head or jaw means positioning in a direction normal to the sagittal plane of the horse's head. The side faces of the horse's head are therefore located on either side of the sagittal plane.

In the method according to the third aspect, the protective element and the outer holding portion are positioned so that the junction portion surrounds the horse's lower jaw when the protective element at least partially covers the mandibular bar in the horse's mouth and the outer holding portion is positioned outside the horse's mouth against the posterior part of the horse's head.

In the method, the protective element positioned in the horse's mouth at least partially covers the mandibular bar so as to prevent a direct contact between the mandibular bar, i.e. the gum covering the mandibular bar, and a bit inserted into the horse's mouth.

In one embodiment, an inner holding portion comprises the protective element. The inner holding portion is positioned in the horse's mouth so that the protective element prevents the direct contact between the mandibular bar and a bit inserted into the horse's mouth.

This method allows to prevent a direct contact between the gum of the mandibular bar and a bit inserted into the horse's mouth. Thanks to this method, the horse's gum is protected in a simple, robust way. The method allows to ensure a correct positioning of the protective element in relation to the mandibular bar, and without the need for custom manufacturing of the protective element. Thanks to this method, the same protection element may be used by different horses with jaws of different shapes and/or sizes.

In the method, the junction portion preferably partially surrounds the horse's lower jaw, and preferably laterally with respect to the horse's mouth. The junction portion may form an arc and/or comprise a curved part.

In this method, the protective element is positioned in the horse's mouth. The protective element at least partially covers the gum of the mandibular bar. The protective element is positioned so as to prevent a direct contact between the gum of the mandibular bar and a bit inserted into the horse's mouth.

The protective element and the outer holding portion are mechanically coupled by a junction portion. In the method, the junction portion is positioned relative to the horse's lower jaw so that, when:
the protective element is positioned in the horse's mouth and at least partially covers the mandible bar so as to prevent the direct contact between the mandibular bar and the bit inserted in the horse's mouth, and
the outer holding portion is positioned outside the horse's mouth and against the posterior part of the horse's head,
   the junction portion partially surrounds the horse's lower jaw.

Preferably, the method comprises the step of:
holding the outer holding portion against the posterior part of the horse's head by means of a bridle attached to the horse's head.

Preferably, the outer holding portion is positioned between a strap of the bridle and the posterior part.

The steps and/or characteristics of the methods according to the second and third aspects of the invention may be combined. These methods are preferably implemented using the protection according to the first aspect of the invention, but not necessarily.

According to a fourth aspect, the invention proposes a protective element for horse gums, comprising a main tongue extending:
along an axis X over a length separating the front and rear ends of the main tongue, and
along an axis Y over a width separating first and second lateral edges of the main tongue, and
along the axis Z from a gingival contact face and over a thickness, the axes X, Y, Z being orthogonal to each other.
   The main tongue is configured to cover a mandibular bar of a horse's mouth when the gingival contact face is positioned against the mandibular bar.

Preferably, the length of the main tongue is between 4 and 15 cm, preferably between 6 and 10 cm, more preferably between 6.5 and 7.1 cm, and most preferably equal to 6.8 cm.

Preferably, the width of the main tongue is between 2 and 40 mm, preferably between 5 and 25 mm. Preferably, the width of the main tongue varies along the axis X, preferably monotonically between the front and rear ends of the main tongue. Preferably, said width at the level of the front end of the protection is between 3 and 8 mm. Preferably, said width at the level of the rear end of the protection is between 15 and 25 mm.

Preferably, the thickness of the main tongue is between 2 and 15 mm, preferably between 3 and 6 mm, more preferably 4 mm.

The main tongue may be configured to at least partially or fully cover a mandibular bar of a horse's mouth when the gingival contact face is positioned against the mandibular bar.

When the gingival contact face of the main tongue is positioned against the mandibular bar, the gingival contact face is oriented towards the mandibular bar, in direct or indirect contact with the mandibular bar.

The main tongue is configured to prevent a direct contact between a horse's mandibular bar and a bit positioned in the horse's mouth when the gingival contact face is positioned against the horse's mandibular bar.

Such a protective element allows to prevent a direct contact between a horse's mandibular bar and a bit positioned in the horse's mouth. This type of protection limits, or even eliminates, the adaptations required for use with different horses. Such a protective element may also be replaced when worn.

The dimensions of the main tongue are chosen so that it may be positioned on the mandibular bar of a horse, by inserting it between the teeth adjacent to the mandibular bar. Preferably, the main tongue is configured to extend over the mandibular bar between an incisor (or canine if the horse has one) and a premolar adjacent to the mandibular bar.

The main tongue may be continuous, and/or comprise through openings, and/or comprise hollows, and/or comprise bumps, and/or comprise a curved part.

Preferably, the main tongue extends longitudinally along the axis X, i.e. mainly along the axis X. The main tongue extends transversely along the axis Y.

Preferably, the main tongue extends along the axis X and in the direction of increasing X from the front end to the rear end of the main tongue.

The length of the main tongue is measured along the axis X. The width of the main tongue is measured along the axis Y. The thickness of the main tab is measured along the axis Z. The axes are secured to the protective element.

Preferably, the protective element has a housing for receiving a rod, the housing extending along the first lateral edge of the main tongue between a first end of the housing equipped with an opening for inserting the rod and a second end of the housing. The housing may extend along at least a portion and preferably along all of the first lateral edge.

Preferably, the first and second ends of the housing are located on the side of the front and rear ends of the tongue, respectively, along the axis X.

The housing preferably extends, along the axis X and in the direction of increase of X, beyond the rear end of the main tongue, so that the second end of the housing is located beyond the rear end of the main tongue along the axis X and in the direction of increase of X.

The housing extends longitudinally along the axis X. Preferably, the housing is configured to insert the rod by translation along the axis X.

Preferably, an internal diameter of the housing measured in a plane normal to the axis X is between 2 and 6 mm. Preferably, a housing depth measured along the axis X is between 5 and 10 cm.

Preferably, the housing is a rectilinear sleeve suitable for receiving a rectilinear rod.

Preferably, the protective element comprises a coupling portion for coupling the element to a holding structure. The holding structure and the coupling portion may be comprised in a protection according to the first aspect of the invention when they are coupled. The coupling portion may comprise the housing for receiving a rod of the holding structure. For example, the rod of the holding structure is comprised in the inner holding portion or the junction portion of the protection according to the first aspect of the invention.

The protective element preferably comprises a rim extending along the second lateral edge of the main tongue, the rim extending along the axis Z from the gingival contact face.

The rim is configured to be positioned between the horse's tongue and the mandibular bar when the protection is installed in the horse's mouth with the gingival contact face against the mandibular bar. In this way, the rim and the main tongue partially surround the mandibular bar. This allows the position of the protective element to be better hold in relation to the horse's mandibular bar.

Preferably, the rim extends along the axis Z and in the direction of decrease of Z over a distance of between 4 and 9 cm, preferably between 5 and 8 cm, from the gingival contact face to a free end of the rim.

The rim therefore forms an angle with the main tongue. The rim protrudes from the gingival contact face. The rim is preferably immobile relative to the main tongue.

The protective element preferably comprises a flap having a junction edge attached to the rear end of the main tongue and a free edge opposite the junction edge.

Preferably, the flap is configured so that the free edge is movable relative to the main tongue. The flap is preferably configured so that the junction edge is immobile relative to the main tongue. Such a flap is preferably orientable in relation to the main tongue.

The flap is preferably flexible. The flap is foldable relative to the main tongue so as to extend mainly along the axis Z. In other words, the flap is preferably orientable relative to the main tongue so as to extend along the axis Z and in the direction of growth of Z from the junction edge coupled to the main tongue to the free edge.

The flap may be positioned so that it extends on the opposite side (along the axis Z) to the rim with respect to the main tongue. The protective element is configured so that the flap may rest against the premolar adjacent to the mandibular bar when the main tongue overlies the mandibular bar with the gingival contact face positioned against the mandibular bar.

In this way, when the gingival contact face of the protection is positioned against the mandibular bar, the flap may be positioned against a premolar adjacent to the mandibular bar so as to prevent a direct contact between the bit positioned in the horse's mouth and the premolar. Such a protective element allows to protect the premolar from contact with the bit, in addition to the mandibular bar.

Preferably, the protective element is in one-part.

Preferably, the protective element is made of a single material, for example thermoplastic. Alternatively, the main tongue may be made of a different material to that of the flap, the housing or the rim.

The protection according to the first aspect of the invention may comprise one and preferably two protection elements according to the fourth aspect of the invention.

The advantages cited above for the protection apply mutatis mutandis to the methods and to the protective element according to the invention.

### BRIEF DESCRIPTION OF THE FIGURES

These aspects and other aspects of the invention will be clarified in the detailed description of particular embodiments of the invention, reference being made to the drawings of the figures, wherein:

FIGS. 1 to 5 show side, top, rear and perspective views of an example of horse gum protection according to the invention;

FIGS. 6 and 7 show perspective views of the horse gum protection of FIGS. 1 to 5, from which the protective elements of the inner holding portions have been removed;

FIGS. 8 and 9 show side and top views, respectively, of an example of horse gum protection according to the invention without the protective elements;

FIGS. 10, 11 and 12 show top, perspective and side views, respectively, of removable protective elements according to the fourth aspect of the invention;

FIG. 13 shows a protection according to the invention coupled to a horse's mandible.

The drawings in the figures are not to scale. Generally, similar elements are denoted by similar references in the figures. The presence of reference numbers in the drawings shall not be considered limiting, even when such numbers are indicated in the claims.

### DETAILED DESCRIPTION OF SOME EMBODIMENTS OF THE INVENTION

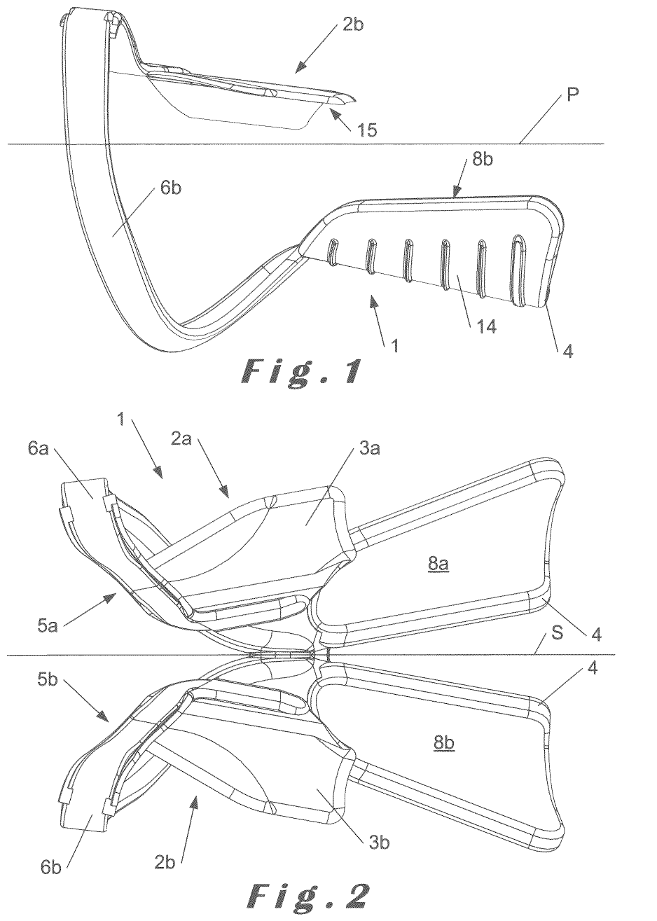

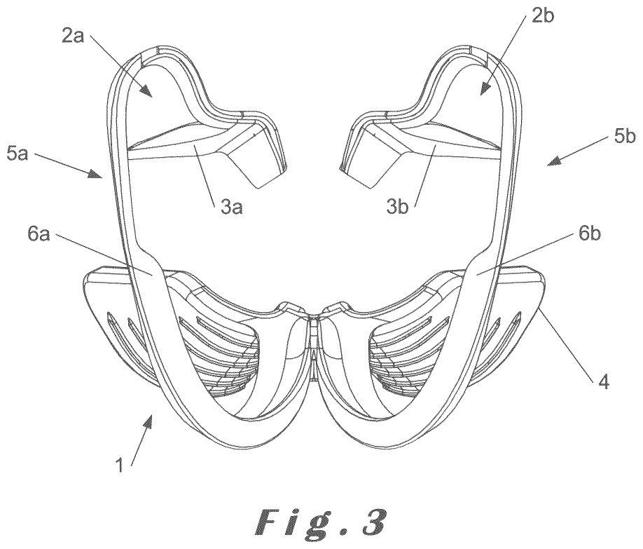

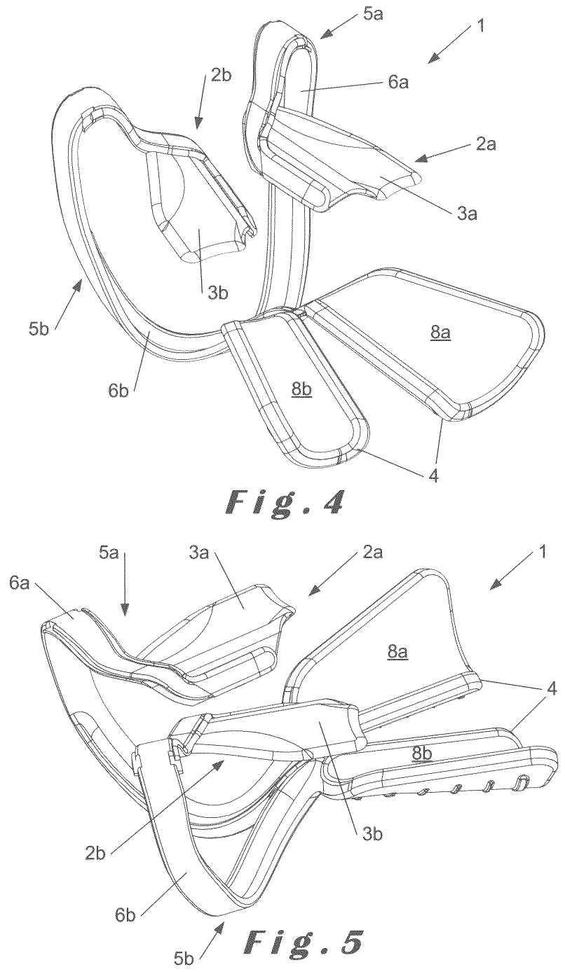

FIGS. 1 to 5 show an example of embodiment of a protection 1 according to the invention, to prevent a direct contact between the gums covering the mandibular bars of a horse and a bit installed in the horse's mouth. The bit or mouthpiece is generally placed in the horse's mouth so that it is in contact with the corners of the horse's lips. The bit, which is installed in the mouth, generally passes right through the mouth and is located in the spaces between the incisors (or canines if the horse has them) and the premolars of the horse's mandible. The bit generally rests on the parts of the horse's gum covering the mandibular bars. The bit is installed in the horse's mouth in such a way as to allow relative movement of the bit in relation to the mandibular bars, which causes rubbing that injures the horse's gums.

As illustrated in FIGS. 1-5, the protection 1 comprises two symmetrical lateral sections 5a, 5b. Each lateral part comprises a respective inner holding portion 2a, 2b. Each inner holding portion 2a, 2b comprises a protective element 3a, 3b. The inner holding portions 2a, 2b are configured to be positioned in a horse's mouth so that their protective elements 3a, 3b each protect a respective mandibular bar.

When the protection 1 is coupled to the horse's lower jaw, each of the protective elements 3a, 3b covers and is supported by a respective mandibular bar of the horse. When the protection 1 is coupled to the horse's lower jaw, each of the protective elements 3a, 3b extends along the respective mandibular bar between the incisor (or canine if the horse has one) and premolar adjacent to the respective mandibular bar. In this way, the incisors (or canines if the horse has them) and the premolars adjacent to the mandibular bars limit the movements of the inner holding portions 2a, 2b towards the front and rear of the horse's mouth and contribute to the coupling of the protection 1 to the horse's mandible.

The protection also comprises an outer holding portion 4 configured to be positioned outside the horse's mouth and against a posterior part of the horse's head. In the protection illustrated in FIGS. 1-5, the outer holding portion 4 is configured to be positioned against the intermandibular region of the horse's head. When the protection 1 is coupled to the horse's lower jaw, the outer holding portion 4 is configured to be held against the intermandibular region of the horse's head by a strap of a bridle attached to the horse's head. The bridle thus limits the possible gap between the outer holding portion 4 and the posterior part of the horse's head.

The outer holding portion 4 shown in FIGS. 1-7 comprises two symmetrical parts, each comprising a respective head posterior part contact surface 8a, 8b for contact with the horse's intermandibular region. The head posterior part contact surfaces 8a, 8b are concave so that they at least partially conform to the posterior part of the horse's head. This reduces the movements of the outer holding portion 4 relative to the horse's intermandibular region and in the lateral direction of the horse's head. In this way, the outer holding portion 4 helps to couple the protection 1 to the horse's head.

The outer holding portion 4 is configured so that the head posterior part contact surfaces 8a, 8b are in contact with the posterior part of the horse's head when the protection is coupled to the mandible of said horse. Preferably, the external surfaces are covered with a soft or flexible material so as to better fit the posterior part of the horse's head. This also reduces rubbing between the posterior part and the outer holding portion 4.

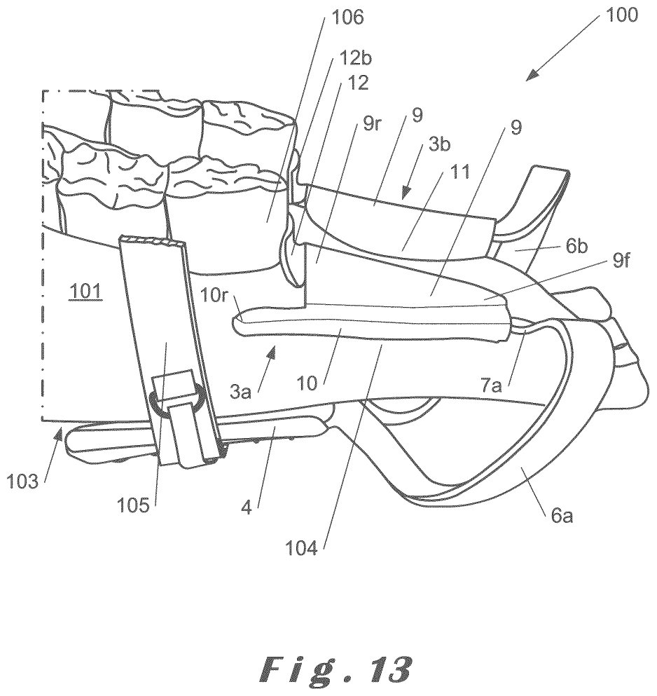

The inner holding portions 2a, 2b and the outer holding portion 4 of the protection are configured to allow the protection to be coupled to the horse's mandible. Preferably, such a coupling further comprises holding the outer holding portion 4 against the posterior part of the horse's head by a strap of a bridle attached to the horse's head, as shown in FIG. 13. The protection coupled to the horse's lower jaw means that the protection is attached to the horse's lower jaw in such a way as to follow its movements.

Each inner holding portion 2a, 2b is mechanically coupled to the outer holding portion 4 via a respective junction portion 6a, 6b. In the protection illustrated in FIGS. 1-7 and 13, the junction portions are symmetrical with respect to a plane of symmetry S of the protection 1, and are arched so as to surround the horse's lower jaw on either side thereof. When the protection 1 is coupled to the horse's lower jaw, each junction portion 6a, 6b therefore provides a mechanical coupling between a respective inner holding portion 2a, 2b positioned in the horse's mouth and the outer holding portion 4 positioned outside the horse's mouth. Preferably, the junction portions 6a, 6b are configured to mechanically couple the inner and outer holding portions in a rigid manner, i.e. without allowing relative displacements between the inner and outer holding portions other than those caused by plastic deformation of the materials constituting the protection.

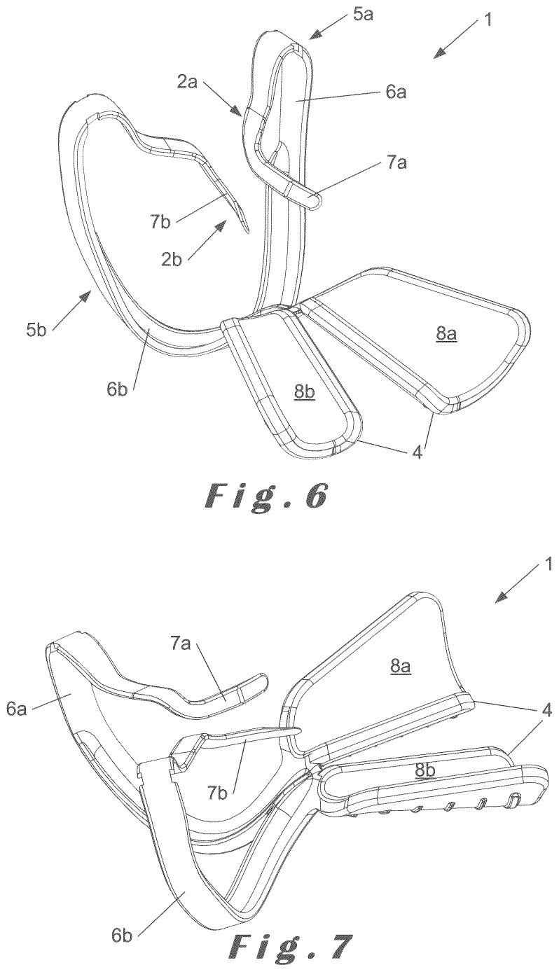

In the protection 1 shown in FIGS. 1-7, the protective elements 3a, 3b are removable from the inner holding portions 2a, 2b. As illustrated in FIGS. 6-7, the inner holding portions 2a, 2b each comprise a coupling portion 7a, 7b for coupling with one of the protective elements 3a, 3b. The protective elements 3a, 3b are configured to be detachably coupled to the inner holding portions 2a, 2b. It is therefore possible to replace the protective elements 3a, 3b of the protection depending on the horse's sensitivity, for example by using protective elements 3a, 3b made from materials of different hardness. More or less flexible protective elements 3a, 3b may, for example, be used on a horse with more or less sensitive mandibular bar gums, respectively.

The protective elements 3a, 3b of the protection may also be replaced as they wear.

It is also possible to replace the protective elements 3a, 3b of the protection depending on the length of the mandibular bar. This means that protective elements of different sizes may be fitted to the protection to accommodate different distances between a horse's incisors (or canines if the horse has them) and premolars, for example. This means that the same protection may be used for horses with mandibular bars of very different lengths, simply by replacing the protective elements.

For example, the protective elements 3a, 3b may be coupled to the inner holding portions 2a, 2b by threading, adhesive bonding, screwing or other mechanical coupling means, preferably rigidly.

In the protection 1 shown in FIGS. 1-7, the outer holding portion 4, the two junction portions 6a, 6b and the coupling portions 7a, 7b are in one-part. In this way, they may be manufactured to form a single piece.

In a second aspect, the invention relates to a method for attaching a mandibular bar gum protection to the mandible of a horse. For example, the protection is gripped by the junction portions 6a, 6b by a person. Next, the inner holding portions 2a, 2b are inserted into the horse's mouth so that each protective element 3a, 3b covers a respective mandibular bar of the horse, and the outer holding portion 4 is positioned outside the horse's mouth against the horse's intermandibular region. Each inner holding portion 2a, 2b comprising a protective element 3a, 3b is positioned on a respective mandibular bar, between the incisor (or canine if the horse has one) and the premolar adjacent to the respective mandibular bar. The outer holding portion 4 is inserted between a strap of a bridle attached to the horse's head and the horse's intermandibular region so as to limit the gap between the outer holding portion 4 and the intermandibular region. Preferably, the bridle is arranged so as to maintain a contact between the outer holding portion 4 and the intermandibular region.

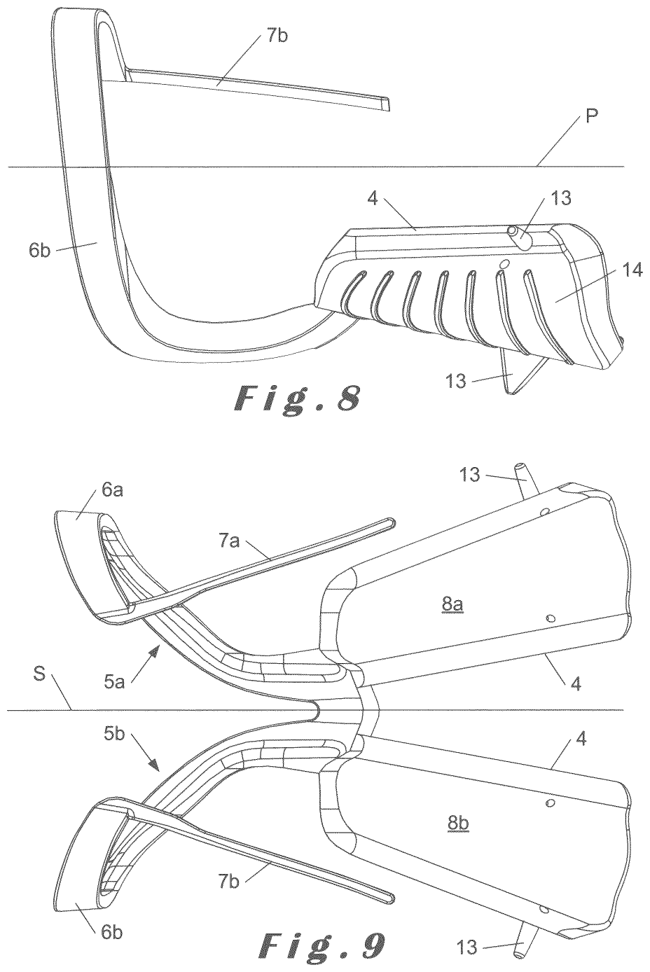

FIGS. 8 and 9 show a preferred embodiment of the protection according to the invention wherein the bridle contact surface 14 comprises protuberances 13 to prevent a displacement of the bridle or of a strap of the bridle along the contact surface 14. This improves the holding of the outer holding portion 4 in relation to the horse's lower jaw 101, as the outer holding portion may not slide alongside the bridle strap 105.

As illustrated in FIGS. 1 and 8, the protection 1 according to the invention may comprise a transverse plane P. As illustrated in FIG. 8, the transverse plane P separates the gingival contact face or faces 15 from the head posterior part contact surface or surfaces 8a, 8b of the protection. The gingival contact surface or surfaces 15 are oriented towards a first face of the transverse plane. The head posterior part contact surface or surfaces 8a, 8b face a second face of the transverse plane opposite the first face of the transverse plane.

This configuration prevents the protection from moving up and down in relation to the horse's mandible. As shown in FIG. 13, when the protection is coupled to the horse's head:
the gingival contact faces 15 prevent a downward movement of the protection, i.e. towards the posterior part of the horse's head,
the head posterior part contact surfaces 8a, 8b prevent an upward movement of the protection.

Preferably, the transverse plane is orthogonal to the plane of symmetry of the protection.

According to a third aspect, the invention concerns a method for protecting a horse's gum. The method comprises the following steps:
at least partially covering a mandibular bar in the horse's mouth with a protective element,
positioning the outer holding portion outside the horse's mouth against the posterior part of the horse's head,
positioning a junction portion mechanically coupling the protective element to the outer holding portion so that, when the protective element at least partially covers the mandibular bar and the outer holding portion is positioned outside the horse's mouth against the posterior part of the horse's head, the junction portion surrounds the horse's lower jaw.

In the method, the junction portion is preferably positioned to at least partially, but not entirely, surround the horse's lower jaw.

In summary, the invention may also be described as follows. Protection 1 for mandibular bar of horse comprising:
an inner holding portion 2a, 2b for positioning in a horse's mouth, preferably relative to a mandibular bar of the horse, and comprising a protective element 3a, 3b;
an outer holding portion 4 to be positioned outside the horse's mouth in contact with a posterior part 103 of a horse's head;

The protection is configured to be attached to a mandible of the horse when:
the inner holding portion 2a, 2b is positioned in the horse's mouth so that the protective element 3a, 3b prevents a direct contact between the mandibular bar and a bit installed in the horse's mouth,
the outer holding portion 4 is positioned outside the horse's mouth and in contact with the posterior part 103 of the horse's head, the outer holding portion preferably being held in contact with the posterior part of the horse's head by a strap of a bridle attached to the horse's head.

The invention therefore concerns a mouth protection which is positioned at the point of action of the horse's mouthpiece, i.e. the bit configured to control the horse. The purpose of this protection is to protect the gums from the action of the mouthpiece and therefore to prevent hyper-sensitivity and injury in the horse's mouth. This improves their well-being and optimizes their sporting performance.

FIG. 13 shows a protection according to the invention in the position of use, i.e. coupled to the lower jaw 101 of a horse's head 100. A bridle 105 is attached to the horse's head. The bit is not shown. When the bit is installed in the horse's mouth, between the two jaws, it is supported by the protective elements 3a, 3b covering the mandibular bars 104.

As shown in FIG. 13, the outer holding portion 4 is positioned against the posterior part 103 of the horse's head. The outer holding portion 4 is also held against the posterior part 103 by means of a bridle 105. In this way, the coupling between the protection and the horse's mandible is held even when the horse shakes its head.

Junction portions 6a, 6b connect the outer holding portion 4 to the protective elements 3a, 3b.

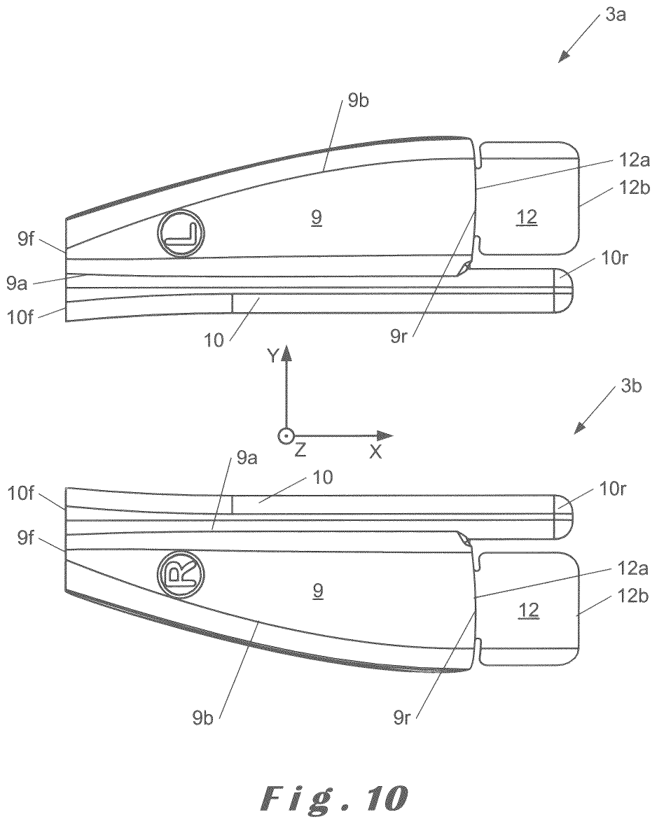

FIGS. 10, 11 and 12 show views of protective elements 3a, 3b according to the invention. Each protective element comprises a main tongue 9 for contacting and covering a respective mandibular bar 104. The main tongue 9 extends along the axis X and in the direction of increase of X from a front end 9f to a rear end 9r of the main tongue 9. When a protective element 9 covers a mandibular bar 104 of the horse as shown in FIG. 13, the axis X is parallel to the length direction of the mandibular bar, and the gingival contact face (not visible in FIGS. 10-12) is in contact with the mandibular bar 104. FIG. 10 shows the face of the main tongue 9 opposite the gingival contact face.

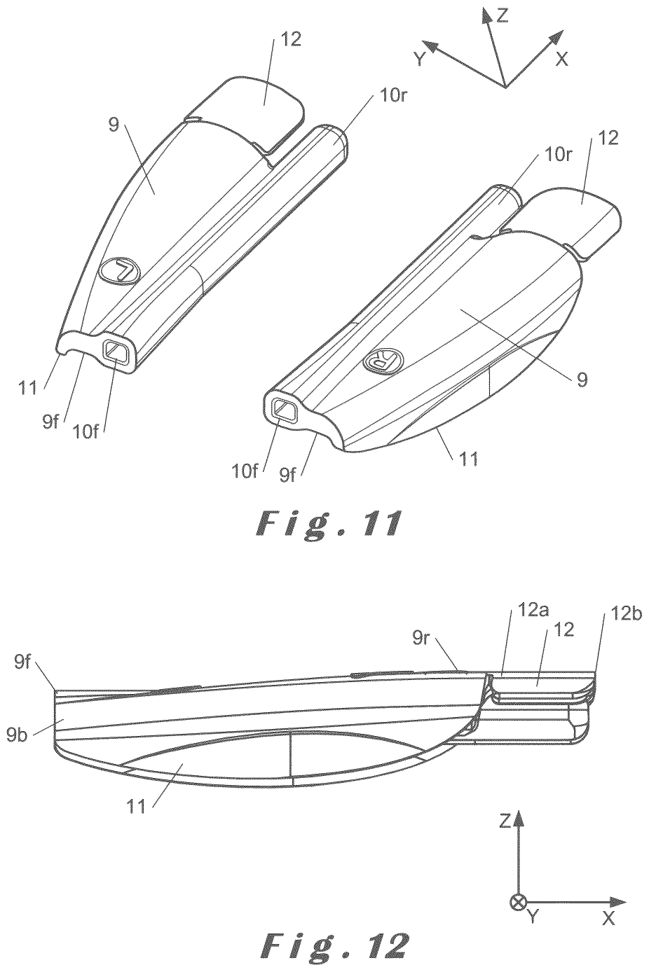

Each protective element comprises a housing 10 for receiving a rod 7a, 7b as shown in FIGS. 8-9. This allows the protective element to be coupled to a structure configured to hold it in the horse's mouth. The housing 10 extends along the axis X between first and second ends 10f, 10r of the housing. The first end 10f of the housing is equipped with an opening visible in FIG. 11 for inserting the rod. The second end 10r of the housing extends beyond the rear end 9r of the main tongue 9.

To limit the lateral movements of the protective elements 3a, 3b in relation to the horse's mouth, they each comprise a rim 11 as shown in FIG. 12. The rim extends from the main tongue 9 in the direction of decrease of Z. In this way, the main tongue 9 and the rim 11 form an angle. Such a protective element allows the mandibular bar to be at least partially surrounded when installed in the horse's mouth. In particular, the rim 11 extends between the tongue and the lower jaw 101 of the horse when the protective element is positioned so as to at least partially cover the mandibular bar.

As shown in FIG. 13, the main tongue 9 prevents a direct contact between a bit installed in the horse's mouth and the gum of the mandibular bar 104.

As illustrated in FIG. 13, the protective element may also be used to protect the premolar 106 adjacent to the mandibular bar 104. To this end, the protective element also comprises a flap 12 as shown in FIGS. 10-13. The flap 12 has a junction edge 12a attached to the rear end 9r of the main tongue 9, and a free edge 12b opposite the junction edge. The flap 12 may be rotated relative to the main tongue 9. For example, as illustrated in FIGS. 10-12, the flap 12 extends mainly along the axis X and in the extension of the main tongue when it is in the rest position. As illustrated in FIG. 13, when the protective element 3a, 3b is positioned in the horse's mouth so that the main tongue 9 covers the mandibular bar, the flap 12 is in a folded position relative to the main tongue 9 and rests on the premolar 106 adjacent to the mandibular bar. In such a position of use, the flap extends mainly along the axis Z. Along the axis Z, the free edge 12b is then located opposite the rim 11 with respect to the main tongue 9.

In FIG. 13, only the horse's lower jaw is shown. The tongue, the cheek and the upper jaw are not represented.

1. A protection device for horse gums, comprising:
an inner holding portion having a protective element and configured to be positioned in a mouth of a horse such that the protective element prevents direct contact between a mandibular bar of the horse and a bit inserted into the mouth of the horse; and
an outer holding portion to be positioned outside the mouth of the horse against a posterior part of a head of the horse.

2. The protection device according to claim 1, further configured to be coupled to a lower jaw of the horse when:
the inner holding portion is positioned in the mouth of the horse so that the protective element prevents the direct contact between the mandibular bar of the horse and the bit in the mouth of the horse; and
the outer holding portion is positioned outside the mouth of the horse and against the posterior part of the head of the horse.

3. The protection device according to claim 1, further comprising two lateral parts each having the inner holding portion, the protection device being configured so that the protective element of each lateral part prevents the direct contact between a respective mandibular bar and the bit.

4. The protection device according to claim 3, further comprising two junction portions, wherein each lateral part is mechanically coupled to the outer holding portion through one of the respective junction portions, the two lateral parts being symmetrical with respect to a plane of symmetry of the protection device.

5. The protection device according to claim 1, wherein the protective element is removably attached to a mechanical coupling portion of the inner holding portion.

6. The protection device according to claim 1, wherein the protective element is attached to a coupling portion of the inner holding portion by adhesive bonding, or wherein the inner holding portion comprising the protective element is one-part.

7. The protection device according to claim 1, wherein the protective element comprises a main tongue for at least partially covering the mandibular bar.

8. The protection device according to claim 1, wherein the outer holding portion is configured to be held against the posterior part of the head of the horse by a bridle attached to the head of the horse.

9. The protection device according to claim 1, wherein the outer holding portion is configured to be positioned against the chin or the intermandibular region of the head of the horse.

10. The protection device according to claim 4, configured to be coupled to a lower jaw of the horse so that:
the protective element at least partially covers the mandibular bar, and
the outer holding portion is positioned against the posterior part of the head of the horse and held against the posterior part by the bridle attached to the head of the horse,
wherein the junction portions are configured to laterally surround the lower jaw of the horse on either side of the lower jaw of the horse.

11. The protection device according to claim 1, wherein the inner holding portion is configured to allow a positioning of the protection device relative to a mandibular bar of the horse, relative to teeth and/or a gum of a lower jaw of the horse.

12. The protection device according to claim 4, wherein coupling portions of the inner holding portion, the outer holding portion, and the junction portions are in a single piece and/or made of thermoplastic such as polypropylene, polyamide, elastomeric thermoplastic or polyurethane thermoplastic.

13. The protection device according to claim 1, wherein the protective element is made of elastomeric thermoplastic or polyurethane thermoplastic.

14. The protection device according to claim 1, wherein the outer holding portion comprises a head posterior part contact surface configured to be brought into contact with the posterior part of the head of the horse, and wherein the head posterior part contact surface is at least partially covered with a layer of soft and/or flexible material.

15. A method for attaching a horse gum protection device to a lower jaw of a horse, comprising:
positioning an inner holding portion of the protection device in a mouth of the horse so that a protective element of the inner holding portion prevents direct contact between a mandibular bar of the horse and a bit inserted into the mouth of the horse; and
positioning an outer holding portion of the protection device outside the mouth of the horse and against a posterior part of a head of the horse.

16. A method for protecting a gums of a horse, comprising:
at least partially covering a mandibular bar in a mouth of the horse with a protective element;
positioning an outer holding portion outside the mouth of the horse against a posterior part of a head of the horse; and
positioning a junction portion mechanically coupling the protective element to the outer holding portion so that, when the protective element at least partially covers the mandibular bar and the outer holding portion is positioned outside the mouth of the horse against the posterior part of the head of the horse, the junction portion surrounds a lower jaw of the horse.

17. The method according to claim 16, further comprising:
holding the outer holding portion against the posterior part of the head of the horse by means of a bridle attached to the head of the horse.

18. A protective element for horse gums, comprising a main tongue extending:
along an axis X over a length separating the front and rear ends of the main tongue;
along an axis Y over a width separating first and second lateral edges of the main tongue; and
along the axis Z and starting from a gingival contact face over a thickness,
wherein the axes X, Y, and Z are orthogonal to each other, and
wherein the main tongue is configured to cover a mandibular bar of a mouth of the horse when the gingival contact face is positioned against the mandibular bar.

19. The protective element according to claim 18, further comprising a housing for receiving a rod, the housing extending along the first lateral edge of the main tongue between a first end of the housing, equipped with an opening for inserting the rod, and a second end of the housing.

20. The protective element according to claim 18, further comprising a rim extending along the second lateral edge of the main tongue, the rim extending along the axis Z from the gingival contact face.

21. The protective element according to claim 18, further comprising a flap having a junction edge attached to the rear end of the main tongue and a free edge opposite the junction edge.
